(19) United States
(12) Patent Application Publication
(10) Pub. No.: US 2005/0140611 A1
(43) Pub. Date: Jun. 30, 2005

(54) Pixel driving circuit

(76) Inventors: Po-Sheng Shih, Taoyuan Hsien (TW); Kei-Hsiung Yang, Taoyuan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/885,379

(22) Filed: Jul. 6, 2004

(30) Foreign Application Priority Data
Dec. 15, 2003 (TW) 92135462

(51) Int. Cl. G09G 3/32

(52) U.S. Cl. 345/82

(57) ABSTRACT

The present invention provides a pixel driving circuit. A photo sensor is used in this driving circuit for sensing light from illumination devices to generate different induced currents. The different induced currents may form different driving currents to drive the illumination devices. Therefore, the illumination period of each illumination device is different but results in a same brightness after integration of each illumination device through a frame time.

### FIELD OF THE INVENTION

The present invention relates to a driving circuit, and more particularly to a pixel driving circuit.

### BACKGROUND OF THE INVENTION

A light emitting diode (LED) is a current driving device. It can emit light by the combination of an electron and an electron hole. With the advances of small size, energy conservation, high contrast ratio and fast response, the light-emitting diode has become the most important illumination device in the next generation of technology.

FIG. 1 illustrates the typical drive circuit 100 for driving a light emitting diode. A pixel region is defined by a cross-connected scan line 102 and the data line 104. A power supply line 106 is arranged in parallel with the data line 104. It is noted that the power supply line 106 is also arranged in parallel with the scan line 102. A switching device 108, a driving device 110, a storage capacitor 112 and a light emitting diode 114 are located in the pixel region.

The gate electrode, source electrode and the drain electrode of the switching device 108 are respectively connected with the scan line 102, data line 104 and the gate electrode of the driving device 110. The drain electrode and the source electrode of the driving device 110 are respectively connected with the power supply line 106 and the light emitting diode 114. The storage capacitor 112 is connected between the gate electrode and the source electrode of the driving device 110.

When the scan line 102 is selected by the gate driving apparatus (not shown in the figure), the switching device 108 is turned on. The data transmitted by the data line 104 is stored in the storage capacitor 112 through the switching device 108. When the switching device 108 is turned off, the data is maintained in the storage capacitor 112 until the switching device is turned on again.

The storage capacitor 112 can maintain the voltage applied to the gate electrode and the source electrode of the driving device 110. Therefore, the drain current of the driving device 110 is controlled by the storage capacitor 112. The drain current is supplied to the light emitting diode 114 through the driving device 110. In other words, after the scan signal transmitted from the scan line 102 selects the switching device 108, the storage capacitor 112 is charged by the signal transmitted from the data line 104. The terminal voltage of the storage capacitor 110 can control the drain current in the power supply line 106.

The current flowing through the light emitting diode 114 is controlled by the driving device 110. The brightness of the light emitting diode 114 is related to the current flowing through the light emitting diode 114. Therefore, the brightness of the light emitting diode 114 is also controlled by the driving device 110. In other words, the drain current of the driving device 110 is determined if a predetermined signal is stored in the storage capacitor 112 through the data line 104. Then, the current for driving the light emitting diode 114 is determined. Therefore, the brightness of the light emitting diode is also determined. FIG. 2 illustrates another typical drive circuit for driving the light emitting diode. Comparing FIGS. 1 and 2, the main difference is the position in which the light emitting diode 114 is connected.

However, it is impossible to get an identical brightness for the light emitting diodes in the typical drive circuit even though the voltage between the gate electrode and source electrode of the driving device 110 is fixed. The main reason is that the threshold voltage of each light emitting diode is different. Additionally, the brightness of the light emitting diode is also affected by the use time of the light emitting diode. Therefore, a drive circuit that is not affected by the parameters associated with the light emitting diode is needed.

### SUMMARY OF THE INVENTION

Therefore, the main purpose of the present invention is to provide a drive circuit to compensate for the difference between the light emitting diodes for providing an identical brightness.

Another object of the present invention is to provide a drive circuit to obtain an identical brightness from the light emitting diodes after a long time of use.

Yet another object of the present invention is to provide a drive circuit to provide a steady light output independent of the variation of parameters associated with the light emitting diodes.

According to the drive circuit and operation method thereof in the present invention, a sensor is used to sense the brightness of the light emitting diode to generate different induced currents to compensate for the brightness difference between the light emitting diodes. The different induced currents can cause different driving currents to drive corresponding light emitting diodes. Therefore, each light emitting diode has a specific illumination period according to its initial brightness. The different illumination periods can make each light emitting diode illuminate with the same brightness within a time frame.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 and FIG. 2 illustrate typical drive circuits for driving light emitting diodes;

FIG. 3 illustrates a schematic diagram of a drive circuit with compensation function according to the present invention;

FIG. 4 illustrates a drive circuit with a compensation function according to the first embodiment of the present invention;

FIG. 5 and FIG. 6 illustrate a waveform diagram of an induced current, brightness and driving current for the present invention; and

FIG. 7 illustrates a drive circuit with a compensation function according to the second embodiment of the present invention.

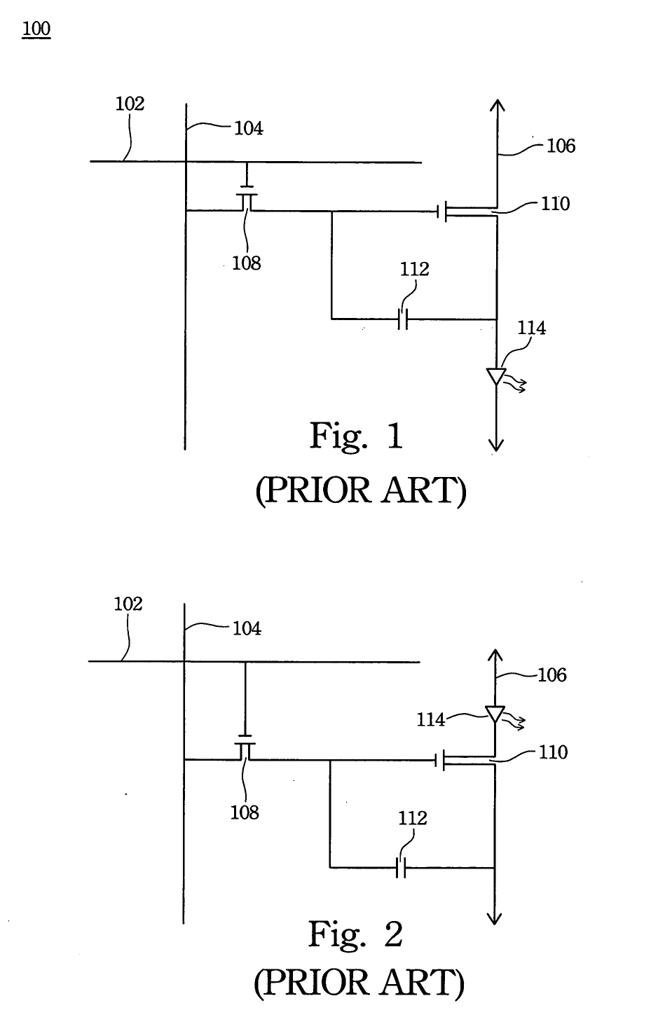

### DETAILED DESCRIPTION OF THE PREFERRED EMBODIMENT

Without limiting the spirit and scope of the present invention, the drive circuit and operation method thereof proposed in the present invention is illustrated with one preferred embodiment. One of ordinary skill in the art, upon acknowledging the embodiment, can apply the drive circuit and operation method of the present invention to various illumination device. Accordingly, it is impossible to obtain an identical brightness between the light emitting diodes driven by a typical drive circuit even though the drive current is fixed. The main reason for the difference in brightness is that the threshold voltage or the use time for each light emitting diode is different. Therefore, the present invention provides a drive circuit and operation method thereof to compensate for the difference between the light emitting diodes independent of the variation of parameters associated with the light emitting diodes, thus obtaining an identical brightness. The present invention is explained by the following detailed embodiments. However, these embodiments do not limit the scope of the present invention.

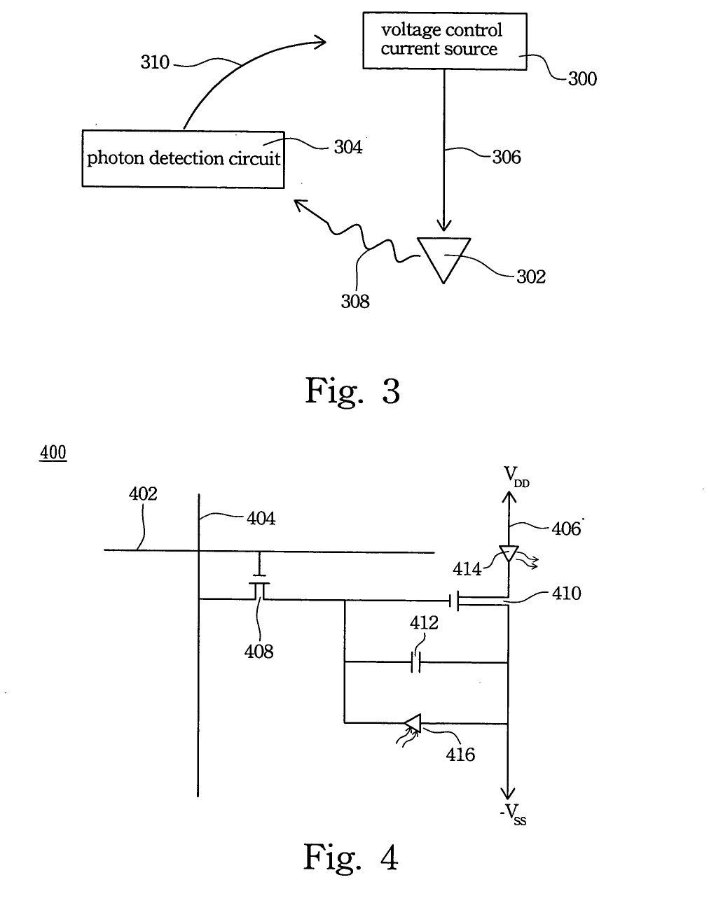

FIG. 3 illustrates a schematic diagram of a drive circuit with compensation function according to the present invention. A voltage control current source 300, an illumination device 302 and a photon detection circuit 304 are used in the present invention. The voltage control current source 300 can provide a constant current 306 to drive the illumination device 302. When the photon detection circuit 304 detects a light 308 emitted from the illumination device 302, a voltage 310 related to the light 308 is generated to control the voltage control current source 300 to change the current 306. In other words, the photon detection circuit 304 is used as a feedback circuit. The light 308 of the illumination device 302 is sent to the voltage control current source 300 through the photon detection circuit 304. Then, the voltage control current source 300 can modulate the current according to the light 308. The modulated current can change the brightness of the illumination device 302.

According to the drive circuit of the present invention, the different brightnesses of the illumination devices 302 can make the photon detection circuit 304 generate different voltages 310 to control the voltage control current source 300. Then, the voltage control current source 300 can generate a corresponding current according to the voltage to drive the illumination device 302. Therefore, though the brightnesses of the illumination devices 302 are different because of the different parameter values, the different brightnesses are sent to the voltage control current source 300 through the photon detection circuit 304 to generate different currents to drive the illumination devices 302. In other words, the different brightnesses of the illumination devices 302 due to the different parameter can be corrected by adding a feedback circuit. The detailed circuit design is described by the following.

FIG. 4 illustrates a drive circuit 400 with compensation function according to the first embodiment of the present invention. A pixel region is defined by a cross-connected scan line 402 and the data line 404. A power supply line 406 is arranged in parallel with the data line 404. It is noted that the power supply line 406 can also be arranged in parallel with the scan line 402. A switching device 408, a driving device 410, a storage capacitor 412 and a sensor 416 and a light emitting diode 414 are located in the pixel region. The sensor 416 is a device that receives photons to generate current, such as a photodiode or a photoconductor or a transistor made of amorphous-silicon channel with a connected gate and drain or an amorphous silicon layer. A transistor can be used as the switching device 408 or the driving device 410.

The gate electrode, source electrode and the drain electrode of the switching device 408 are, respectively, connected with the scan line 402, data line 404 and the gate electrode of the driving device 410. The source electrode and the drain electrode of the driving device 410 are, respectively, connected with a low power source (−Vss) and the light emitting diode 414. The storage capacitor 412 is connected between the gate electrode and the source electrode of the driving device 410 for controlling the voltage between the gate electrode and the source electrode of the driving device 410. A sensor 416 is connected in parallel with the two terminals of the storage capacitor 412 for detecting the brightness of the light emitting diode 414. A photocurrent is generated when the sensor 416 detects the brightness of the light emitted from the light emitting diode 414. The voltage on the storage capacitor 412 is discharged by photocurrent to change the voltage between the gate electrode and the source electrode of the driving device 410.

When the scan line 402 is selected by the gate driving apparatus (not shown in the figure), the switching device 408 is turned on. The data transmitted by the data line 404 is stored in the storage capacitor 412 through the switching device 408. When the switching device 408 is turned off, the data is maintained in the storage capacitor 412 until the switching device 408 is turned on again.

The storage capacitor 412 can maintain the voltage applied to the gate electrode and the source electrode of the driving device 410. Therefore, the drain current of the driving device 410 is controlled by the storage capacitor 412. The drain current is supplied to the light emitting diode 414 through the driving device 410. An induced current is generated when the sensor 416 detects the brightness of the light emitting diode 414. The storage capacitor 412 is discharged to reduce its voltage applied to the gate electrode and the source electrode of the driving device 410. The reduced voltage reduces the drain current of the driving device 410. Therefore, the brightness of the light emitting diode 414 is also reduced. The reduced brightness generates a lower induced current. The induced current continues to discharge the storage capacitor to reduce the voltage between the gate electrode and the source electrode of the driving device 410 until the drain current is reduced to nearly zero. At this time, the light emitting diode 414 does not emit any light. Therefore, the sensor 416 does not generate any induced current.

The capacitance value of the storage capacitor 412 is C and the terminal voltage of the storage capacitor 412 is V₀. The threshold voltage of the driving device 410 is V_{T}. The induced current with which the sensor 416 detects the brightness of the light emitting diode 414 is I₄₁₆. Then, the induced current I₄₁₆ is related to the charge Q stored in the storage capacitor 412. In a time frame, the relationship between the current I₄₁₆ and the charge Q is described by the following:
Q=C(V₀−V_{T})=∫I₄₁₆dt

The induced current I₄₁₆ is related to the brightness, B_{LED}, of the light emitting diode 414. That is, that a functional relationship exists between them. Therefore, the relationship can be expressed by the following:
I₄₁₆=ƒ(B_{LED})

Therefore, the total brightness of the light emitting diode 414 in a time frame is equal to sum or integration of the gray levels displayed in the time frame. This is described by the following:
Gray level=∫B_{LED}dt

According to the foregoing description, the brightness generated by the light emitting diode 414 in a time frame is obviously related to the induced current. In other words, the different brightnesses of the light emitting diodes 414 due to different parameter values or different use times can induce different induced currents, I₄₁₆, through the light emitting diode 416. The different induced currents I₄₁₆ generate different driving currents I₄₁₄. The different driving currents I₄₁₄ can correct the different brightnesses to an identical brightness of the light emitting diodes 414.

Accordingly, the relation between the Gray level and the B_{LED} is described by the following:
Gray level=∫B_{LED}dt and I₄₁₆=ƒ(B_{LED})

On the other hand, the relation between the current I₄₁₆ and the charge Q is described by the following:
Q=C(V₀−V_{T})=∫I₄₁₆dt

Therefore, the Gray level is related to the Q. That is related to the voltage V₀ that is the voltage from the data line. In other words, the characteristic of the special LED does not influence the gray level.

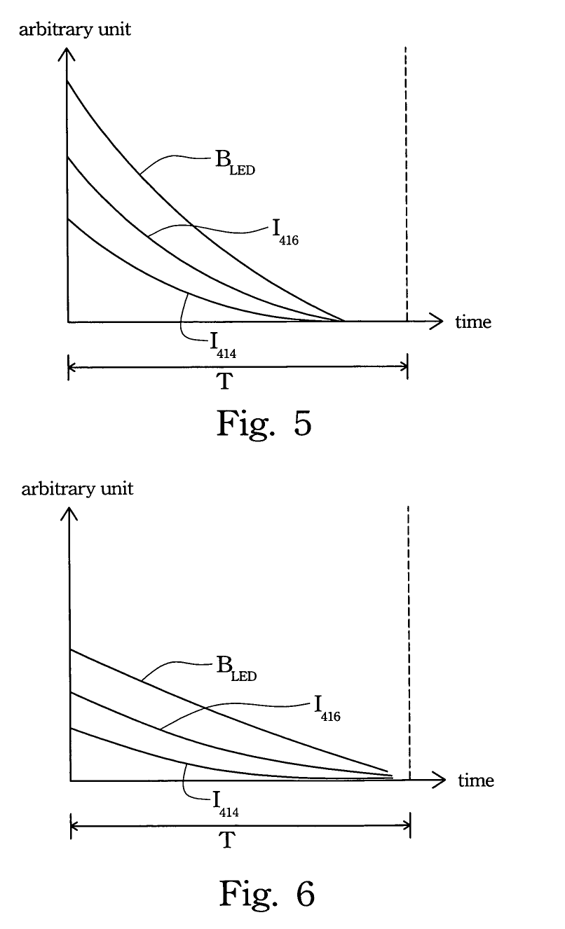

FIG. 5 and FIG. 6 illustrate a waveform relation diagram for the induced current I₄₁₆ generated by the sensor 416, brightness B_{LED} emitted from the light emitting diode 414 and the driving current I₄₁₄ flowing through the light emitting diode 414. The brightness B_{LED} emitted from the light emitting diode 414 can make the sensor 416 generate an induced current I₄₁₆. The induced current I₄₁₆ can control the driving current I₄₁₄ flowing through the light emitting diode 414. Therefore, if the brightness B_{LED} is reduced, the induced current I₄₁₆ is also reduced. The reduction of the current I₄₁₆ can reduces the driving current I₄₁₄.

Comparing FIG. 5 with FIG. 6, the period T is the frame time. The B_{LED} is the brightness emitted from the light emitting diode 414. Therefore, the brightness emitted from the light emitting diode 414 in a frame time T is described in the following:
Brightness=∫₀^{T}B_{LED}dt

If the brightness B_{LED} emitted from the light emitting diode 414 is increased, a larger induced current I₄₁₆ is generated. The larger induced current I₄₁₆ can discharge the storage capacitor 412 faster, that makes a larger voltage reduction between the gate electrode and the source electrode of the driving device 410. Therefore, the current flowing through the light emitting diode 414 also has a larger reduction. Similarly, the drain current for driving the light emitting diode 414 also has a larger reduction. In other words, a larger brightness causes a sharper change in the induced current I₄₁₆, the brightness B_{LED} and the driving current I₄₁₄ through the light emitting diode 414. Therefore, a shorter time is required to change the brightness of the light emitting diode to dark as shown in FIG. 5. Conversely, a smaller brightness causes a smoother change in the induced current I₄₁₆, the brightness B_{LED} and the driving current I₄₁₄ through the light emitting diode 414. Therefore, a longer time is required to change the brightness of the light emitting diode to dark as shown in the FIG. 6.

In other words, the different brightnesses of the light emitting diodes 414 due to the different parameter values or the different use times can induce different induced currents I₄₁₆. The different induced currents I₄₁₆ generate different driving currents I₄₁₄ to drive corresponding light emitting diodes. Therefore, each light emitting diode has a special illumination period according to its initial brightness. The different illumination period within a frame time associated with each light emitting diode results in the same brightness. In other words, the different driving current I₄₁₄ can be compensated by a different brightnesses resulting in an identical perceived brightness for the light emitting diodes 414 integrated across a frame time.

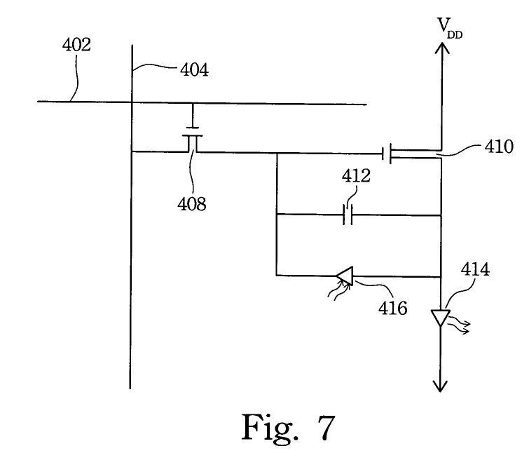

FIG. 7 illustrates a drive circuit with compensation function according to the second embodiment of the present invention. Comparing FIG. 4 with FIG. 7, the main difference is the connected position of the light emitting diode 414.

According to the drive circuit and operation method thereof in the present invention, a sensor is used to sense the brightness of the light emitting diode to generate different induced currents to compensate for the brightness difference between the light emitting diodes. The different induced currents can cause different driving currents to drive corresponding light emitting diodes. Therefore, each light emitting diode has a special illumination period according to its initial brightness but resulting in the same brightness integrated through frame time.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

1. A pixel drive circuit, comprising:
an illumination device;
a voltage control current source for providing a drive current to said illumination device; and
a photon detection circuit for generating a voltage related to a brightness emitted from said illumination device, wherein said voltage controls said voltage control current source to generate a corresponding drive current.

2. The pixel drive circuit of claim 1, wherein said illumination device is a device driven by current.

3. The pixel drive circuit of claim 1, wherein the brightness of said illumination device is B and the brightness emitted from said illumination device in a frame time T is described in the following:
Brightness=∫₀^{T}Bdt

4. The pixel drive circuit of claim 1, wherein said illumination device is a light emitting diode.

5. The pixel drive circuit of claim 1, wherein said photon detection circuit comprises a sensor and a capacitor.

6. The pixel drive circuit of claim 5, wherein said sensor is a transistor having a connected gate electrode and drain electrode.

7. The pixel drive circuit of claim 5, wherein said sensor is an amorphous silicon layer.

8. The pixel drive circuit of claim 5, wherein said sensor and said capacitor are arranged in parallel, and said sensor generates a current to discharge said capacitor.

9. The pixel drive circuit of claim 5, wherein said sensor is a device and said device receives photons to generate current.

10. The pixel drive circuit of claim 1, wherein said voltage control current source is a transistor.

11. The pixel drive circuit of claim 1, wherein said voltage control current source is a thin film transistor.

12. A pixel drive circuit, comprising:
a scan line;
a data line crossing said scan line;
a switching device respectively connected to said scan line and said data line, wherein said scan line turns on said switching device;
a driving device connected with said data line through said switching device;
a capacitor connected with said data line through said switching device, wherein said capacitor stores the charge transmitted from said data line to build a terminal voltage for said driving device and said driving device generates a corresponding drive current;
an illumination device connected with said driving device, wherein said illumination device generates a corresponding brightness according to said drive current; and
a sensor arranged in parallel with said capacitor, wherein said sensor generates a current to discharge said capacitor.

13. The pixel drive circuit of claim 12, wherein said sensor can sense the light from said illumination device to generate a corresponding current.

14. The pixel drive circuit of claim 12, wherein the brightness of said illumination device is B and the brightness emitted from said illumination device in a frame time T is described in the following:
Brightness=∫₀^{T}Bdt

15. The pixel drive circuit of claim 12, wherein said sensor is a device and said device receives photons to generate current.

16. The pixel drive circuit of claim 12, wherein said sensor is a transistor having a connected gate electrode and drain electrode.

17. The pixel drive circuit of claim 12, wherein said sensor is an amorphous silicon layer.

18. The pixel drive circuit of claim 12, wherein said illumination device is a device driven by current.

19. The pixel drive circuit of claim 12, wherein said illumination device is a light emitting diode.

20. The pixel drive circuit of claim 12, wherein said driving device is a voltage controlled device, and said voltage controlled device generates a corresponding drive current according to an applied voltage.

21. The pixel drive circuit of claim 12, wherein said driving device is a transistor.

22. The pixel drive circuit of claim 12, wherein said switching device is a transistor.

23. A method for driving a illumination device, comprising:
using a sensor to detect a brightness of light emitted from said illumination device to generate a corresponding current;
using said current to discharge a capacitor to change a terminal voltage of said capacitor;
applying said terminal voltage to a driving device to generate a corresponding drive current; and
supplying said drive current to said illumination device.

24. The method of claim 23, wherein the brightness of said illumination device is B and the brightness emitted from said illumination device in a frame time T is described in the following:
Brightness=∫₀^{T}Bdt

25. The method of claim 23, wherein said illumination device is a device driven by current.

26. The method of claim 23, wherein said illumination device is a light emitting diode.

27. The method of claim 23, wherein said sensor is a device, and said device receives photons to generate current.

28. The method of claim 23, wherein said sensor is a transistor having a connected gate electrode and drain electrode.

29. The method of claim 23, wherein said sensor is an amorphous silicon layer.

30. The method of claim 23, wherein said sensor and said capacitor are arranged in parallel.

31. The method of claim 23, wherein said driving device is a voltage controlled device, and said voltage controlled device generates a corresponding drive current according to an applied voltage.

32. The method of claim 23, wherein said driving device is a transistor.
